(19) United States
(12) Patent Application Publication
(10) Pub. No.: US 2008/0004874 A1
(43) Pub. Date: Jan. 3, 2008

(54) Method and device for protected transmission of data words

(75) Inventors: Franz Klug, Munich (DE); Thomas Kunemund, Munchen (DE); Steffen Sonnekalb, Taufkirchen (DE); Andreas Wenzel, Munchen (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG

(21) Appl. No.: 11/405,500

(22) Filed: Apr. 18, 2006

(30) Foreign Application Priority Data
Mar. 18, 2005 (DE) DE 102005012632.4

(51) Int. Cl. G10L 15/16

(52) U.S. Cl. 704/232

(57) ABSTRACT

Method for protected transmission of data words includes providing a first data word, transforming the first data word into a sequence including at least one second data word using a first transformation rule, transforming at least one of the second data words into a third data word using a second transformation rule, and checking whether a prescribed relationship exists between the third data word and a comparison data word.

### CROSS-REFERENCE TO RELATED APPLICATION

This application claims priority to German Patent Application Serial No. 10 2005 012 632.4, which was filed Mar. 18, 2005, and is incorporated herein by reference in its entirety.

### BACKGROUND OF THE INVENTION

The invention relates to a method and a circuit arrangement for the protected transmission of data words.

Circuit arrangements for data processing essentially comprise an arithmetic and logic unit, a memory and also peripheral units and a bus for data interchange between the arithmetic and logic unit, the memory and the peripheral units. The operation of the circuit arrangements can be impaired by errors in the hardware or external sources of interference.

Previous safety concepts for protecting the data processing within a circuit arrangement have concentrated on protecting just a portion of the circuit arrangement. By way of example, providing a cryptographic unit allows data in the memory to be protected against incorrect use when read without authorization. In this context, the data to be stored in the memory are encrypted before being stored and are decrypted again when they are loaded, so that the memory contains the data only in encrypted form.

Another protection option is the use of error-correcting codes. In this context, a data word has redundant information added to it which allows changes in individual bits to be recognized and corrected. Error-correcting codes can be used both to protect the data in the memory and during data transmission, for example via the bus. Data transmission via the bus can also be protected by encrypting the data during the transfer.

In the measures cited above, the protection for the data is limited to areas of the circuit arrangement outside of the arithmetic and logic unit.

With regard to new attack scenarios, comprising local or wide-area attacks using light or heat, new safety concepts are changing to no longer prevent errors during data transmission but rather merely recognize them and initiate a suitable reaction from the circuit arrangement.

### BRIEF DESCRIPTION OF THE DRAWINGS

The invention is explained below using exemplary embodiments with reference to the drawing, in which:

FIG. 1 show an exemplary embodiment of a method for the protected transmission of data words,

FIG. 2 shows a further exemplary embodiment of the method for the protected transmission of data words,

FIG. 3 shows yet a further exemplary embodiment of the method for the protected transmission of data words,

FIG. 4 shows an exemplary embodiment of a circuit arrangement for the protected transmission of data words, and

FIG. 5 shows a further exemplary embodiment of the circuit arrangement for the protected transmission of data words.

### DESCRIPTION OF THE INVENTION

The invention to provides a method for protected data transmission which can be used to check the entire data traffic as far as the arithmetic and logic unit, and also a suitable circuit arrangement.

The method for the protected transmission of data words involves provision of a first data word, transformation of the first data word into a sequence comprising at least one second data word by a first transformation rule, transformation of at least one of the second data words into a third data word by a second transformation rule, and checking whether a prescribed relationship exists between the third data word and a comparison data word.

The invention also specifies a circuit arrangement for the protected transmission of data words which is suitable for use of the cited method.

Fundamental components of a circuit arrangement for the actual data processing are a memory and an arithmetic and logic unit. The memory contains the program code to be executed as a series of data words which comprise data and instructions. A set of possible instructions from which the data words of the program code are chosen is usually chosen such that it can be processed not just by one particular arithmetic and logic unit architecture, but rather can be used in different circuit arrangements or arithmetic and logic units.

The data words in the program code cannot be processed by the arithmetic and logic unit directly, since the arithmetic and logic unit has its own instruction set which is usually optimized for the arithmetic and logic unit architecture or more frequent demands. This instruction set in the arithmetic and logic unit differs from the instruction set in the program data, which is as flexible as possible and needs to cope with a large number of demands. For this reason, a first transformation device, which is also called a decoder, is provided in order to translate the first data words in the program data into second data words, matched specifically to the arithmetic and logic unit. The second data words are instruction words for the arithmetic and logic unit. Each first data word is translated into a sequence of data words which comprises one or more second data words. The second data words which are output by the first transformation device are processed by the arithmetic and logic unit.

The second data words are generated specifically for the arithmetic and logic unit, which needs to process the second data words. There are arithmetic and logic units for which a first data word is translated into a sequence containing just one second data word. There are arithmetic and logic units for which a first data word is translated into a sequence containing a plurality of second data words. In this context, it is naturally conceivable for the resultant sequence for a few first data words to comprise just one second data word. The latter arithmetic and logic units are normally simple and flexible arithmetic and logic units.

The advantage of the method is that no action is taken in the actual data processing of the first or second data words. Rather, the second data words are simultaneously used as control information for the first data words which are based on them. A check is carried out to determine whether the first and second data words still fit together after the data transmission. If this is not the case, it can be assumed that there is an error in the data transmission which is possibly caused by an attack.

The first and second data words are tapped off at suitable points in the circuit arrangement. Suitable points are preferably upstream and downstream of the first transformation device, which converts the first data words into the second data words. The second data word is checked, as described below, to determine whether it has a prescribed relationship with a comparison data word.

The decoder may also be of multistage design. It is conceivable for the second data words to be tapped off between the decoder stages. In this case, the first transformation device corresponds to the decoder stages between the taps. It is likewise conceivable for the first transformation device to comprise a plurality of decoders which are connected downstream of one another. Further decoders may be provided upstream and/or downstream of the taps. The first transformation rule then relates to the transformations carried out between the taps. The choice of tap allows a tradeoff between complexity and scope of protection.

For checking purposes, the second data word is subjected to a second transformation. The second transformation is chosen such that its result matches a comparison data word when no error has arisen during the transmission. The comparison data word is advantageously the first data word. It is also conceivable for the third data word and the comparison data word to have a prescribed relationship. Inversion or shifting are conceivable relationships, as is a match between selected bit positions within the data words. The latter is not a unique relationship between two data words, however. A set of data words may satisfy this relationship. For the error recognition, however, it is advantageous if the relationship is such that a data word has the comparison data word distinctly associated with it.

If each first data word is converted during the first transformation into a sequence containing precisely one second data word, the method normally comprises mutually inverse first and second transformations if the comparison data word is the first data word.

If a sequence containing a plurality of second data words is generated from the first data word during the decoding, just one of these second data words frequently cannot be used to obtain a distinct inference regarding which first word is to be attributed the second data word. On account of the simpler structure of the arithmetic and logic unit, the latter's instruction set is frequently smaller than the set of possible first data words. Consequently, the same second data word is part of different sequences which are obtained when various first data words are transformed. A single second data word within the sequence allows no further inference of the underlying first data word. A plurality of first data words may be used. For this reason, the result of the second transformation of a second data word, which is considered independently of the other second data words in the sequence, may comprise a set containing possible first data words, which may include the second data word. Since the distinct relationship between a single second data word and the underlying first data word has already been lost during the first transformation, this relationship also does not exist after the second transformation of the second data word. The first and third data words therefore no longer have a distinct relationship. Rather, there is then a relationship between a third data word and a plurality of first data words.

To improve protection, it is desirable for the result of the second transformation to allow a distinct inference of the first data word, which is associated with the second data word. For this reason, the generated second data words advantageously have additional information added to them revealing that first data word from which the second data word has been transformed. This practice is useful when the second data word is within a sequence containing a plurality of second data words which have been converted from the first data word. Second data words which occur within a plurality of possible sequences can therefore always be associated with the first data word underlying this sequence separately from the sequence. This means that a distinct relationship between the first and third data words can also be ensured after a second transformation.

Frequently, the circuit implementation of the second transformation rule as a reverse transformation of the first transformation rule gives rise to difficulties. In this case, the second transformation is in the form of just a partial reversal of the first transformation. The result provided for the second transformation is then not the original first data word but rather a third data word. To be able to compare the third data word with the first data word, the first data word is likewise transformed. A third transformation used for this needs to be chosen such that its result matches the result of the first transformation together with the subsequent partial reversal of this through the second transformation, or results in the comparison data word, which has the prescribed relationship with the third data word.

A circuit arrangement based on the method outlined above comprises further blocks in addition to the conventional circuit arrangement for data processing. The first transformation device converts the first data word into the second data word or into the sequence of second data words. Advantageously, the second data word is tapped off upstream of the arithmetic and logic unit and is converted by means of a second transformation device into the third data word, which can be compared with the first data word. This is done using a checking device.

If the second transformation device does not permit full reversal of the first transformation, a third transformation device needs to be provided between the memory and the checking device, so that the third transformation device and the string comprising the first and second transformation devices deliver a respective data word, which are then able to be checked to determine whether the prescribed relationship exists.

If the first, possibly transformed, data word and the third data word do not match, the checking device executes an alarm function, for example an alarm signal.

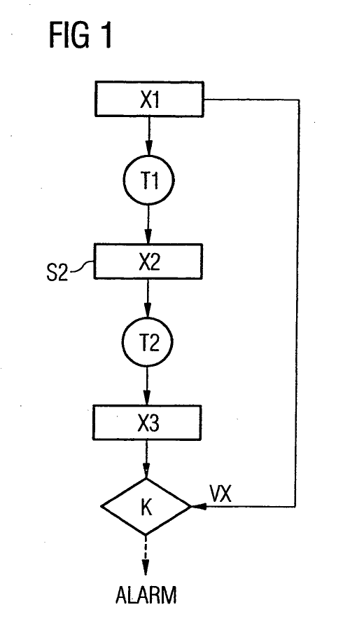

FIG. 1 shows an exemplary embodiment of a method for checking a first data word X1 which is converted into a second data word X2.

First of all, the basic cycle of the inventive method will be illustrated using a simple exemplary embodiment. A first transformation T1 is used to generate a sequence S2 of data words from a first data word X1. In the case illustrated, the sequence S2 comprises precisely one second data word X2.

The second data word X2 is converted into a third data word X3 by means of a second transformation T2. In this case, a prescribed relationship exists between the third data word X3 and the first data word X1. Ideally, “prescribed relationship” means that the third data word X3 is identical to the first data word X1. This is the case when the second transformation T2 is a reverse transformation of the first transformation T1.

A check K is used to check whether a prescribed relationship exists between the third data word X3 and a comparison data word VX. In this case, the comparison data word VX is the first data word X1. If the second transformation T2 is the reverse function of the first transformation T1, this involves a check for identity between the first data word X1 and the third data word X3. If the third data word X3 and the first data word X1 do not have the prescribed relationship, or these data words are not identical, an alarm function ALARM is performed.

The alarm function ALARM may be in many different forms and is also dependent on the use of the method. Details in this regard can be found in the description of the circuit arrangement.

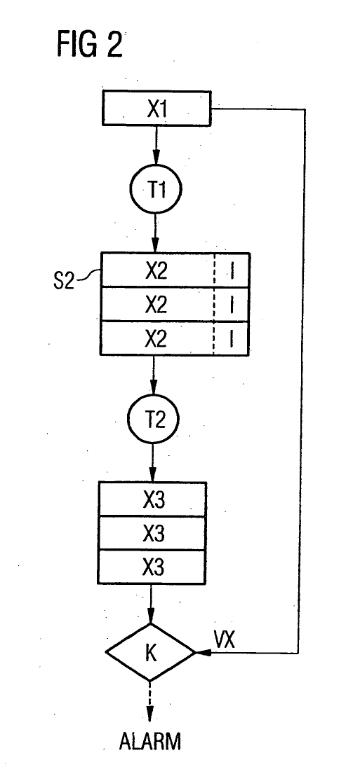

FIG. 2 shows a further exemplary embodiment of the method for the protected transmission of data words. In this case, the first data word X1 is transformed into a sequence S2 comprising a plurality of second data words X2 by the first transformation T1.

In these cases, it is no longer necessarily possible to associate with each individual one of the second data words X2 in the sequence S2 distinctly with the first data word X1. Since the set of possible data words which is intended for the arithmetic and logic unit is smaller, the same second data words X2 are converted into different possible sequences S2 which are respectively associated with a first data word X1. This means that a single data word X2 is no longer distinctly associated with the first data word X1, but rather the sequence S2 comprising a plurality of second data words X2 as a whole.

Depending on the first data word X1, the number of second data words X2 in the relevant sequence S2 may vary. It is also conceivable for the sequence S2 to comprise just a single second data word X2.

The second transformation T2 is used to convert each of the second data words X2 into a third data word X3. There is no guarantee that the first data word X1 can be inferred from an individual, second data word X2 within the sequence S2. This means that after the second transformation T2 the first and one of the third data words X3 are not necessarily in a distinct relationship. It is not necessarily possible to infer the underlying first data word X1 from a third data word X3. However, it is possible, by way of example, to infer a set of possible first data words X1 from the third data word X3. In this case, the error recognition is restricted. The check K then checks whether the original first data word X1 is contained in the set of possible first data words which is obtained after the second transformation T2. If this is not the case, it is possible to infer an error. If the set of possible first data words does comprise the original first data word X1, on the other hand, two possibilities are conceivable. The transmission was error-free or, if the transmission produced an error, this error resulted in a set of possible first data words which likewise comprises the original first data word X1.

An example is intended to illustrate the problem. It is assumed that the program code contains an instruction “ADD-SHIFT” as first data word X1. “ADD-SHIFT” adds two register addresses and shifts the resultant address by one bit. In addition, an instruction “ADD-LOAD” is assumed to be provided as a further first data word X1, which involves two register addresses being added and the resultant address being passed to the system in order to load a data item from this address. The first transformation T1 converts the instruction “ADD-SHIFT” into a sequence S2 containing an “ADD” instruction and a “SHIFT” instruction as second data words X2. The instruction “ADD-LOAD” is converted into a sequence S2 containing an “ADD” instruction and a “LOAD” instruction as second data words X2. In both sequences S2, the “ADD” instruction appears first of all as the first of the second data words X2. If just this second data word X2 in the two sequences S2 is considered, it is not possible to distinguish whether the underlying first data word X1 is the instruction “ADD-SHIFT” or “ADD-LOAD”. The first data word X1 can be inferred only from “ADD”. The second data word X2 can originate either from the first data word “ADD-SHIFT” or from the first data word “ADD-LOAD”. In this example, an error can be inferred from “ADD” only if the first data word X1 is neither “ADD-SHIFT” nor “ADD-LOAD”.

To increase the safety of the method, each second data word X2 is attributed information I after the first transformation T1, so that the resultant second data word X2 can be distinctly associated with the first data word X1.

In the example above, by way of example, the second data word X2 “ADD” has a bit, “0” or “1”, added to it from which it is possible to tell whether the first data word X1 is an “ADD-SHIFT” instruction or an “ADD-LOAD” instruction. By way of example, an “ADD0” is transformed into an “ADD-SHIFT”, and an “ADD1” is transformed into an “ADD-LOAD”. Each of the third data words X3 is thus distinctly in a prescribed relationship with the underlying first data word X1. This means that it is also possible to use the second transformation T2 to output a third data word X3 which can be distinctly associated with the first data word X1. The check K checks the prescribed relationship. If the relationship does not exist, an alarm function ALARM is performed.

Advantageously, the third data words X3 are identical to the first data word X1. Since identical third data words X3 are generated from a first data word X1 using different second data words X2, the second transformation T2 is not a unique depiction. In this exemplary embodiment too, the first data word X1 is the comparison data word VX.

For safety reasons, each second data word X2 in the sequence S2 should be converted into a respective third data word X3, which are compared with the relevant comparison data word VX, in this case the first data word X1. Alternatively, it is conceivable to subject just a portion of the second data words X2 to the second transformation T2 and to check them.

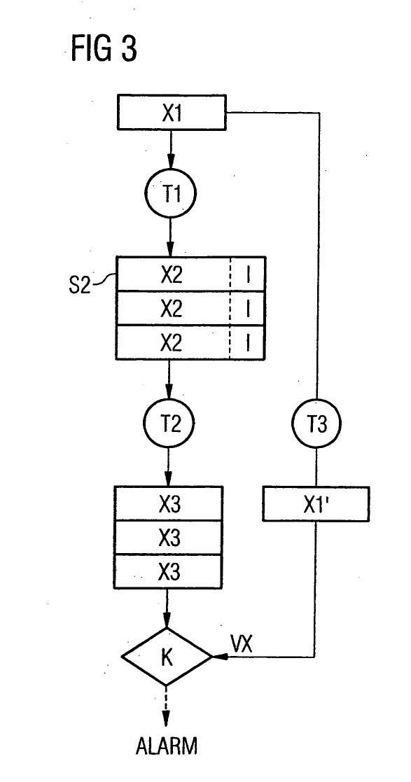

FIG. 3 shows a further refinement of the method. It differs from the method shown in FIG. 2 by means of a third transformation in the path between the first data word X1 and the check K. For this reason, only the differences are discussed below.

In this exemplary embodiment, the second transformation T2 is chosen such that it is not a reverse transformation of the first transformation T1. In this case, the third data words X3 do not match the first data word X1. To be able to perform a check K for identity nevertheless, the first data word X1 is subjected to a third transformation T3. The third transformation T3 is chosen such that it delivers the same result as the string comprising the first and second transformations T1, T2.

In the extreme case, the first, second and third transformations T1, T2, T3 can be chosen such that the second transformation T2 is identity, i.e. the input and the output of the transformation are the same. This would be equivalent to omitting the circle T2 in FIG. 3. In this case, the first and third transformations T1, T3 are the same depiction when the check K for identity is performed.

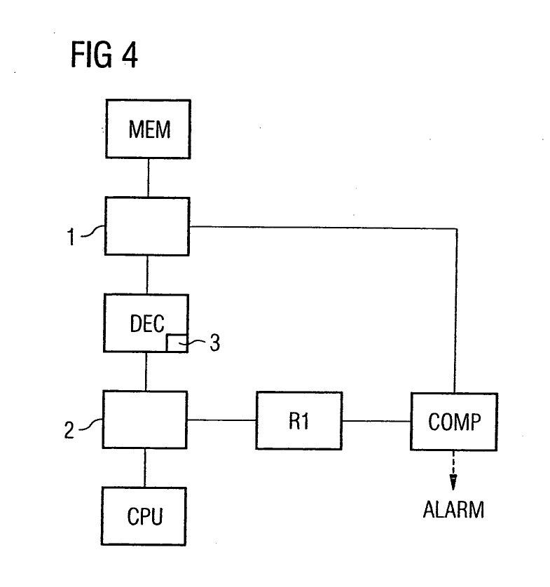

FIG. 4 shows a circuit arrangement in which the method described is used. The circuit arrangement comprises a memory MEM and an arithmetic and logic unit CPU. It will be noted that the memory MEM may also be a buffer store which is connected downstream of an actual main memory.

To match the first data words X1 provided for data processing in the memory MEM, a first transformation device DEC is provided which matches the first data words X1 in a program code to the instruction set in the arithmetic and logic unit CPU. This corresponds to the first transformation T1 outlined above. The architecture of the arithmetic and logic unit and of the first transformation device DEC may, as one alternative, be chosen such that it is a “RISC” architecture, in which each first data word X1 is attributed a sequence S2 containing precisely one second data word X2. It may also be a CISC architecture, in which the first data word X1 is converted into a sequence S2 comprising a plurality of second data words X2. The number of second data words X2 in the sequence S2 may vary. A sequence S2 containing just one second data word X2 is also conceivable in this context.

The data are loaded from the memory MEM via a plurality of buffer stages. FIG. 4 shows a first buffer stage 1 and a second buffer stage 2, by way of example, which are connected upstream and downstream of the first transformation device DEC. The first buffer device 1 provides the first data words X1 for the first transformation device DEC. From the second buffer stage 2, the second data words X2 are provided for the downstream arithmetic and logic unit CPU for the actual processing. Along the path described, the actual data processing of the data words takes place from the memory MEM to the arithmetic and logic unit CPU. It would also be conceivable to tap off the first and second data words X1, X2 directly upstream and downstream of the first transformation device DEC. The taps can also be made directly downstream of the memory MEM and/or upstream of or even by the arithmetic and logic unit CPU. The protected area is dependent on the choice of taps along the data transmission path.

To verify whether the second data word X2 provided for the arithmetic and logic unit CPU is correct in the second buffer device 2, or has been manipulated on the way there, a second transformation device R1 and a checking device COMP are provided. The checking device COMP is coupled both to the second buffer 2 via the second transformation device R1 and to the first buffer 1. The second transformation device R1 is designed to convert the second data word X2 into the third data word X3.

The checking device COMP is designed to check an applied data word and an applied comparison data word VX against one another for a prescribed relationship. Normally, this involves a comparison for identity between the applied third data word X3 and the first data word X1 as comparison data word VX. If the two data words to be checked are not identical or linked in a defined manner, an alarm function ALARM is performed.

In the second transformation device R1, the data word is transformed from the second buffer 2. This transformation corresponds to the second transformation T2. It is advantageously chosen such that this is a reverse function for the first transformation T1 provided by the first transformation device DEC. If no attack or transmission error has occurred, the third data word X3, which is present at the output of the second transformation device R1 and is passed to the checking device COMP, is identical to the first data word X1. In the case of data errors which are random or caused by manipulations, the first and third data words X1, X3 no longer have a prescribed relationship, since the errors within the context of the first and/or second transformations T1, T2 lead to subsequent errors or are caused by the attack during the transformation itself. Since the first and second transformations T1, T2 differ, it is difficult to make the attack such that both transformations are manipulated in coordinated fashion, that data alterations remain unnoticed or that their consequences are removed for the transformations. During an extended attack, for example using light, both transformations deliver different errors which are detected during the comparison.

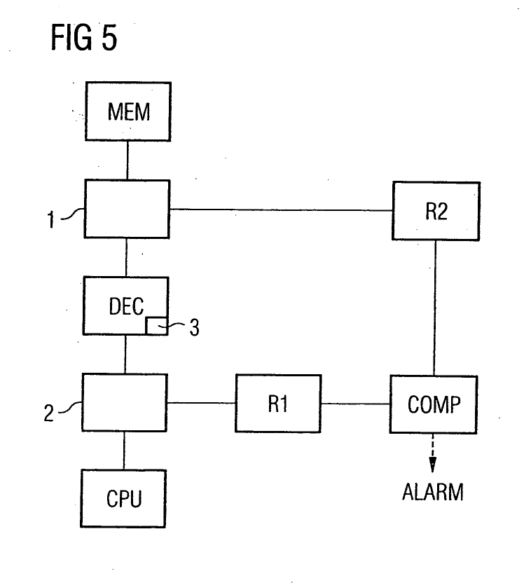

FIG. 5 differs from FIG. 4 merely in that a third transformation device R2 is coupled between the first buffer 1 and the checking device COMP. The text below discusses only the differences.

Producing the hardware implementation of the reverse function in the second transformation device R1 is frequently a difficulty. In these cases, it is not possible to design the second transformation device R1 such that the original first data word X1 is present at its output again. In such cases, only a partial reverse transformation is performed in the second transformation device R1, the result of which is the third data word X3. The still outstanding portion of the reverse function is moved to the path between the first buffer 1 and the checking device COMP. For this, the third transformation device R2 is provided. R2 is designed such that it is used to produce the third transformation T3. This means that ideally the same data word is present at the output of the third transformation device R2 as at the output of the second transformation device R1. Alternatively, the data words may also be in a different, prescribed relationship. These data words are compared with one another in the checking device COMP.

In the extreme case, the second transformation device R1 may be in a very simple form or may be dispensed with completely, so that the second buffer 2 would be connected directly to the checking device COMP. This corresponds to the identity as second transformation T2. In such cases, the third transformation T3, which is provided via the third transformation device R2, is advantageously the same as the first transformation T1, which is executed in the first transformation device DEC. The same transformation is therefore executed on two paths. This refinement of the circuit arrangement has the drawback that it is naturally possible for an identical attack to be made on two identically working devices, which results in the same errors, so that manipulation would remain undetected in the checking device COMP. In the embodiments described above, two or even three different transformation devices DEC, R1, R2 are provided on which different, coordinated attacks would need to be made in order for these attacks to remain undetected.

The first transformation device DEC and the second transformation device R1 both in FIG. 4 and in FIG. 5 may advantageously be in a form such that the resultant third data word X3 can be associated distinctly or cannot be associated distinctly. The latter is often the case when the first data word X1 is converted into a sequence S2 of second data words X2 by the first transformation device DEC.

If the third data word X3 cannot be associated distinctly, that is to say that a plurality of possible first data words can be associated with the third data word X3, the checking device COMP establishes merely whether the association is conclusive. Alternatively, the first transformation device DEC, for example by virtue of an internal device 3, is in a form such that information 1 is added to the second data word X2, so that the first data word X1 and the comparison data word VX, be it the first data word X1 or its transformed form X1′, can be put into a distinct relationship. In this case, the second transformation device R1 also delivers a third data word X3, which corresponds distinctly to the first data word X1 or to its transformed form X1′ at the output of the third transformation device R2. It is also conceivable for the information 1 to be provided by a separate device, coupled to or in parallel with the first transformation device DEC.

With regard to the reaction of the circuit arrangement to an alarm function ALARM which may need to be executed, it should be noted that these may be in a wide variety of forms. They depend both on the safety concept and on the architecture of the circuit arrangement. By way of example, it is conceivable for an alarm signal to be output, for the circuit arrangement to be shut down, for the circuit arrangement to be shut down and started up again, or for the erroneous data word to be subjected to repeat data processing.

In addition, it should be noted that the inventive method is not just limited to conventional circuit arrangements for the actual data processing. It is also conceivable to use it to protect access to a memory device. In this case, a check is carried out to determine whether the requested data word has been manipulated in the course of the request and the upload.

1-21. (canceled)

22. A method for protected transmission of data words, comprising:
providing a first data word;
transforming the first data word into a sequence comprising at least one second data word using a first transformation rule,
transforming at least one of the second data words into a third data word using a second transformation rule; and
checking whether a prescribed relationship exists between the third data word and a comparison data word.

23. The method as claimed in claim 22, further comprising executing an alarm function if the prescribed relationship does not exist between the third data word and the comparison data word.

24. The method as claimed in claim 23, wherein the alarm function is a function selected from the group consisting of outputting an alarm, shutting down the circuit arrangement, shutting down and starting up the circuit arrangement, and subjecting the third data word to repeat data processing.

25. The method as claimed in claim 22, further comprising, prior to the step of transforming at one of the second data words, modifying the at least one second data word such that a distinct relationship exists between the third data word and the comparison data word.

26. The method as claimed in claim 25, wherein the step of modifying the at least one second data word comprises adding information to the at least one second data word.

27. The method as claimed in claim 22, wherein a distinct relationship exists between the third data word and the comparison data word.

28. The method as claimed in claim 22, wherein the distinct relationship is an identity of the third data word with the comparison data word.

29. The method as claimed in claim 22, wherein the first data word is the comparison data word.

30. The method as claimed in claim 22, wherein the second transformation rule is a reverse depiction of the first transformation rule.

31. The method as claimed in claim 22, further comprising transforming the first data word to produce the comparison data word by a third transformation rule.

32. The method as claimed in claim 31, wherein the result of the third transformation rule applied to the first data word is in the prescribed relationship with the result of the application of the second transformation rule after the first transformation rule to the first data word.

33. The method as claimed in claim 31, wherein the second transformation rule is identity and the first and third transformation rules are the same.

34. A circuit arrangement for protected transmission of data words, comprising:
a data input connected to a first transformation device, which is configured to transform a first data word applied to the data input into a sequence of data words which comprises at least one second data word;
a second transformation device, which is coupled to the first transformation device, is configured to transform at least one of the second data words into a third data word; and
a checking device, which has the third data word and a comparison data word supplied thereto, is configured to check whether the third data word and the comparison data word are in a prescribed relationship.

35. The circuit arrangement as claimed in claim 34, further comprising an alarm configured to perform an alarm function if the third data word and the comparison data word are not in the prescribed relationship.

36. The circuit arrangement as claimed in claim 35, wherein the alarm function is a function selected from the group consisting of outputting an alarm, shutting down the circuit arrangement, shutting down and starting up the circuit arrangement, and subjecting the third data word to repeat data processing.

37. The circuit arrangement as claimed in claim 34, wherein the first data word is supplied to the checking device as the comparison data word.

38. The circuit arrangement as claimed in claim 34, further comprising a device configured to modify the second data word such that the prescribed relationship between the comparison data word and the third data word is distinct.

39. The circuit arrangement as claimed in claim 34, wherein the first transformation device is configured to modify the second data word such that the prescribed relationship between the comparison data word and the third data word is distinct.

40. The circuit arrangement as claimed in claim 34, further comprising a third transformation device, which is connected upstream of the checking device, and is configured to transform the first data word applied to the data input into the comparison data word.

41. The circuit arrangement as claimed in claim 40, wherein the second transformation device is configured such that the third data word matches the second data word.

42. The circuit arrangement as claimed in claim 40, wherein the first and third transformation devices are configured to execute the same transformation.

43. The circuit arrangement as claimed in claim 34, wherein the prescribed relationship is identity of the comparison data word and the third data word.

44. The circuit arrangement as claimed in claim 34, further comprising an arithmetic and logic unit and a memory device, wherein the first transformation device is arranged between the arithmetic and logic unit and the memory device.

45. The circuit arrangement as claimed in claim 34, further comprising at least one further transformation device connected upstream and/or downstream of the first transformation device.

46. The circuit arrangement as claimed in claim 34, wherein the data input is a buffer stage.

47. The circuit arrangement as claimed in claim 44, further comprising a buffer stage, which is connected downstream of the first transformation device, and is configured to provide the at least one second data word to the arithmetic and logic unit.
